(19) United States
(12) Patent Application Publication
(10) Pub. No.: US 2012/0148485 A1
(43) Pub. Date: Jun. 14, 2012

(54) STEAM METHANE REFORMING PROCESS

(76) Inventors: JEFFREY M. MORROW, WILLIAMSVILLE, NY (US); MONICA ZANFIR, AMHERST, NY (US); RAYMOND F. DRNEVICH, CLARENCE CENTER, NY (US)

(21) Appl. No.: 12/964,163

(22) Filed: Dec. 9, 2010

(51) Int. Cl. C01B 3/24; B01J 19/00

(52) U.S. Cl. 423/650; 422/623

(57) ABSTRACT

The present invention provides a steam methane reforming process and system utilizing an integrated steam system having both high pressure and low pressure steam circuits. According to this invention, substantially the entire stream of treated boiler feed water leaving the deaerator is pressurized and sent to the boiler feed water heater at elevated pressures. The resulting high pressure heated boiler feed water is split with a portion used as the feed to make low pressure steam and the balance is sent to the high pressure steam circuit.

### FIELD OF THE INVENTION

The present invention relates generally to a process and system for the production of synthesis gas and/or hydrogen by steam reforming. More particularly, this invention relates to the integrated two level steam system for managing heat recovery and use in a steam methane reforming process to increase the energy efficiency of the process.

### BACKGROUND OF THE INVENTION

Steam methane reforming (SMR) processes for the production of synthesis gas are well known. The steam methane reforming process involves reacting a hydrocarbon feedstock (such as natural gas, refinery gas, or naphtha) with steam at elevated temperatures (up to about 900° C.) and in the presence of a catalyst to produce a gas mixture primarily made up of hydrogen and carbon monoxide, commonly known as syngas. While syngas is used as a feed gas for multiple processes, the use of syngas for the production of hydrogen is the primary commercial application of the SMR process. Hydrogen production incorporates several integrated systems which can be viewed as subprocesses of the entire process. For example, these systems can be roughly described as four subprocesses: i) feed gas pretreatment, ii) reforming and heat recovery (including the steam system), iii) carbon monoxide conversion (water gas shift reaction), and iv) hydrogen purification (typically hydrogen PSA). In the United States alone, steam methane reforming accounts for approximately 95% of the hydrogen produced from light hydrocarbon feedstocks.

Significant research is focused on reducing capital equipment investment and/or operational and maintenance costs in SMR processes. For example, the heat recovery system manages the heat energy used for a number of integrated processes such as feed water heating, evaporation, superheating, and gas conditioning. Relatively small improvements in the heat recovery system can have a significant impact on improving the overall efficiency of the entire process for syngas and hydrogen production.

The steam systems used to recover the heat from the hot process and flue gases associated with steam-methane reformers (SMRs) are generally designed to operate at pressures high enough to permit mixing of steam with natural gas at pressures slightly above the operation pressure of the SMR, typically the steam pressures are above 400 psia. The pressure of the steam product is often required to be increased when high pressure steam is exported for use outside the reforming subprocess, also referred to as being outside the SMR battery limits. Since boiling temperature increases with increased pressure, production of high pressure steam can result in large quantities of unrecovered heat ultimately being rejected to the atmosphere thereby reducing the thermal efficiency of the process and adding to the overall costs. Recently, efficient two level steam systems with both high and low pressure stream circuits have been taught as a way to optimize the heat recovery. But current systems require additional equipment in the form of multiple feed water pumps which adds capital cost, adds operational complexity to the process, and adds maintenance costs to the plant. It would therefore be desirable to maximize the efficiency of a two level system by reducing the added costs and complexity of the prior design.

U.S. Pat. No. 7,377,951 discloses steam-hydrocarbon reforming process using a two level steam system. With respect to the steam system of this process, the feed water is heated, sent to a boiler feed water (BFW) preparation system (deaerator), and then split with a portion being pumped to the low pressure boiler and the other portion being pumped to the BFW heater. A first portion of low pressure steam from the low pressure boiler is sent back to the BFW preparation system and the second, and any additional portions, can be used for other purposes. The portion of the BFW sent to the BFW heater is then sent to the high pressure steam circuit.

The present invention provides an SMR process and system utilizing an integrated two level steam system, e.g. having both high pressure and low pressure circuits, while minimizing the equipment requirements and maximizing plant efficiency and reliability. More specifically, the present process modifies the prior two level steam system by directing all of the BFW from the deaerator (BFW preparation step) and pumping it to the BFW heater. A portion of the resulting heated high pressure BFW is then depressurized and used as the feed for making low pressure steam with the balance being sent to the high pressure steam circuit.

### BRIEF SUMMARY OF THE INVENTION

The present invention provides a steam methane reforming process and system utilizing an integrated two level steam system, e.g. having both high pressure and low pressure steam circuits within the overall steam system. The inventive process takes the entire flow of the BFW from the deaerator and pumps it to the BFW heater at elevated pressures. A portion of the resulting heated high pressure BFW is then depressurized and used as the feed for making low pressure steam with the balance being sent to the high pressure steam circuit. This process requires only one set of BFW pumps thereby saving on capital equipment and provides heated high pressure BFW to the high pressure steam system. Energy savings result from the production and use of low pressure steam from low level heat available from the process gases and the use of that heat to reduce fuel requirements and/or increase the quantity of steam of steam available for export without increasing fuel requirements.

According to this invention, a process and system is provided for the steam reforming of hydrocarbons to produce hydrogen using a reformer, a water shift reactor, and a hydrogen PSA and incorporating an integrated steam system for processing boiler feed water and steam, the steam system being in fluid communication with the process for steam reforming, the process comprising:
heating boiler feed water to form a heated boiler feed water;
deaerating the heated boiler feed water to make a treated boiler feed water;
pressurizing the treated boiler feed water to make a pressurized boiler feed water;
heating substantially the entire pressurized boiler feed water to near boiling temperature to produce a high pressure heated boiler feed water;
separating the high pressure heated boiler feed water into at least a first portion and a second portion;
feeding the first portion of the high pressure heated boiler feed water to a high pressure steam unit to make saturated boiler feed water to produce high pressure steam;
feeding the second portion of the high pressure heated boiler feed water to a low pressure steam unit for making a low pressure steam; and
sending the low pressure steam and the high pressure steam to one or more applications within the process for steam reforming or outside the process for steam reforming.

### BRIEF DESCRIPTION OF THE DRAWINGS

FIG. 1 is a schematic flow diagram of a conventional steam-methane reforming process;

FIG. 2 is a schematic flow diagram of the portion of the process shown in FIG. 1 that are pertinent to the present invention;

FIG. 3 is a schematic flow diagram of generally the same portion of the process as shown in FIG. 2 taken from U.S. Pat. No. 7,377,951;

FIG. 4 is a schematic flow diagram of the same portion of the process shown in FIGS. 2 and 3 showing one embodiment of the present invention;

FIG. 5 is a schematic flow diagram of the same portion of the process shown in FIGS. 2-4 showing another embodiment of the present invention.

### DETAILED DESCRIPTION OF THE INVENTION

The present invention is a modification to a conventional steam methane reforming process. Generally, a light hydrocarbon feedstock is reacted with steam at elevated temperatures (typically up to about 900° C.), and elevated pressures of about 200 to 550 psig (about 14 to 38 bar) in Group VIII metal-based catalyst filled tubes to produce a syngas. Most typically, the metal is nickel or nickel alloys. The syngas product gas consists primarily of hydrogen and carbon monoxide, but other gases such as carbon dioxide, methane, and nitrogen, as well as water vapor will normally be present. Subsequent water shift and hydrogen purification processes result in the production of high purity hydrogen. Of particular interest is the efficiency of the reforming process, and more particularly the hydrogen production process, as affected by the efficiency of the heat recovery systems.

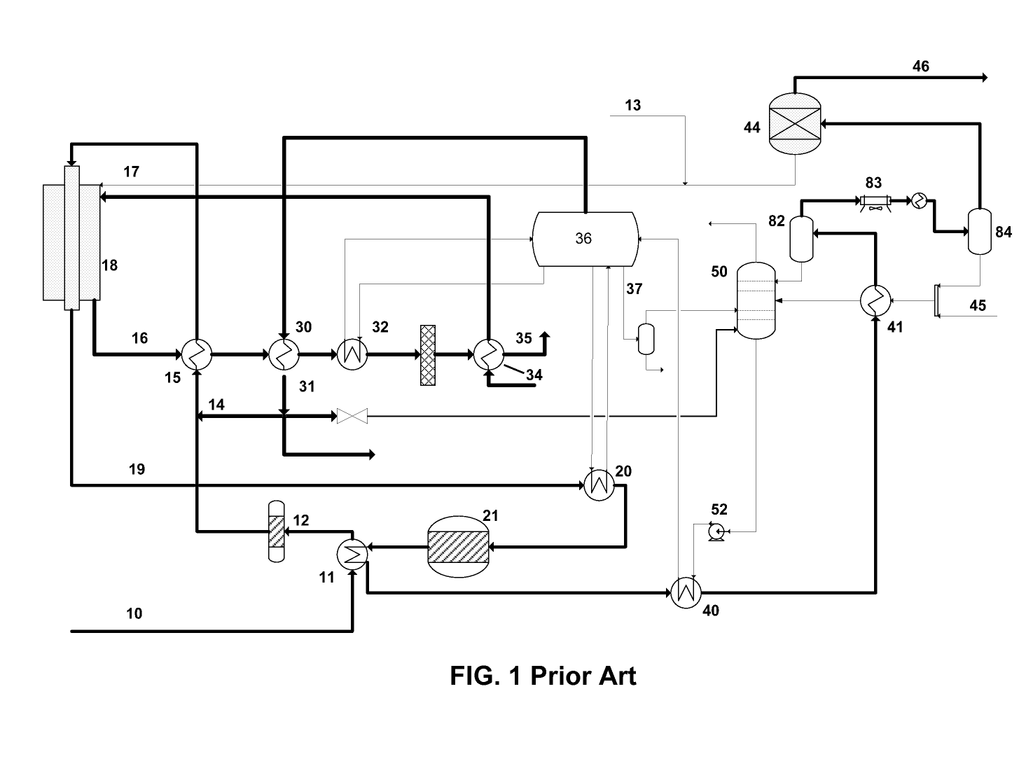

FIG. 1 shows a simplified schematic of a conventional steam methane reforming process to produce hydrogen which does not use a two level steam system. Such processes are well known. The process integrates the process gas reforming system with a typical steam system to recover the heat energy of the combustion and process gases. A pressurized hydrocarbon feed gas (10), such as natural gas, optionally mixed with a small quantity of product hydrogen, is fed to a preheater (11), then to a pretreatment system (12), normally consisting of a hydrotreater and a zinc oxide sulfur removal bed, and then to a feed pre-heater (15) where it is heated by the flue gas (16) exiting the reformer (18) before being sent into the catalyst filled tubes in reformer (18) to undergo the steam reforming reaction at elevated temperatures and pressures. Steam at elevated pressure is added to the feed gas (10) through line (14) as the feed gas enters the pre-heater (15). The flue gas (FG) heats the steam exiting the high pressure steam drum (36), typically designed to operate at a pressure between about 600 psig and about 1500 psig (about 41 to 103 bar), through superheater (30) as shown. The FG continues to FG boiler (32) and air preheater (34) before being discharged to the flue stack (35).

Process gas (PG) (19) is sent to the PG Boiler (20) to produce steam and then to shift reactor (21) to undergo the water shift reaction to increase the concentration of hydrogen. The PG exiting shift reactor (21) is used to heat the feed gas through preheater (11) where it is cooled and sent to the BFW heater (40) to preheat the BFW to temperatures near its boiling point, (typically a 10 to 50 F approach to the boiling point of the BFW) and then to water heater (41), typically a deminerialized (demin) water heater, to preheat water for the de-aerator. The process gas exits water heater (41), and sent to first separator (82) where condensed water is removed, then to cooling system (83), typically an air cooler followed by a water cooled heat exchanger, to reduce the process gas temperature to near ambient, then to second separator (84) for removing additional condensate. After leaving second separator (84), the PG is sent to the hydrogen PSA (44) to separate hydrogen gas from the other process gasses to produce the hydrogen product gas (46). PSA tail gas and make-up fuel (13) are mixed to form stream (17) and sent to burners located in the SMR furnace. The mixed fuel formed by the feed gas and make-up fuel is burned in pre-heated air from air pre-heater (34) to provide the heat needed to drive the endothermic reforming reactions.

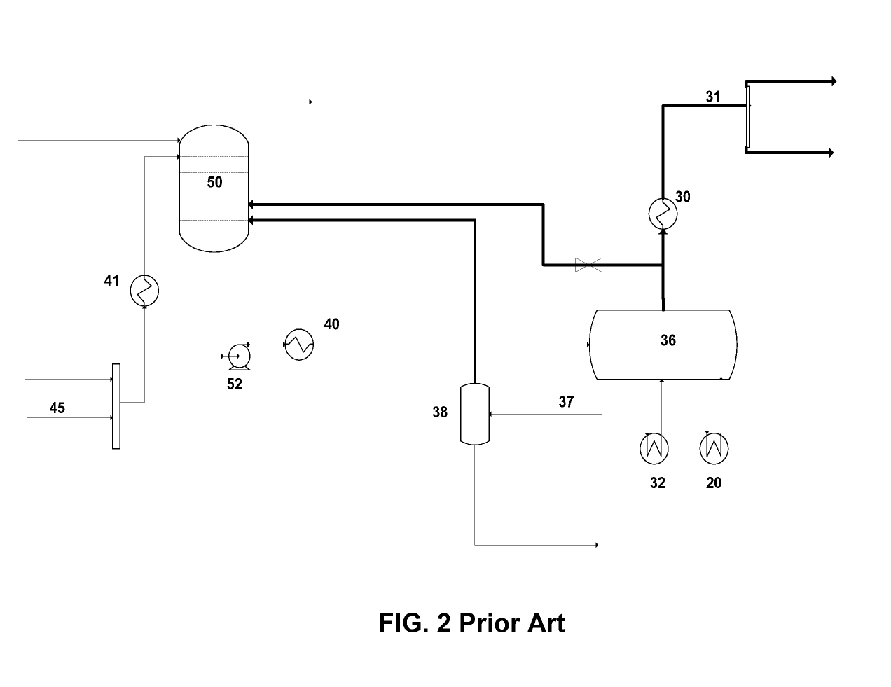

The steam system manages the heat recovery and usage and provides steam to the reformer, recovers sensible heat from the combustion flue and process gasses, as well as providing steam at elevated pressures to applications outside the SMR battery limits. The steam system is best seen by reference to FIG. 2 wherein the numbered elements coincide with the numbered elements in FIG. 1. All of the numbered elements will carry the same designated number for all Figures if the element is common to all processes. One skilled in the art will understand the integration of the subprocesses as shown in FIGS. 2 through 4 into the steam methane reforming process shown in FIG. 1.

Referring now to FIG. 2, the BFW, a combination of cold condensate from second separator (84) in FIG. 1 and make-up water (45), is heated in water heater (41) and sent to deaerator (50). The deaerator is used for the removal of air and other dissolved gases from BFW before being sent to the BFW heater (40). The deaerators can be either tray-type or spray-type units. Other treatments or pretreatments of the incoming or circulating BFW can also incur at this step. After treatment in deaerator (50), the treated or deaerated BFW is pressurized by pump (52), and then heated in BFW heater (40) to make a high temperature BFW. The high temperature BFW is fed to the high pressure steam drum (36) and vaporized by the FG boiler (32) and PG boiler (20) before being sent to superheater (30) to convert the saturated steam to dry steam. The dry steam is sent through line (31) back to the reforming process, exported to applications outside the SMR battery limits, or both as shown. A portion of the saturated steam is depressurized for use in deaerator (50) as shown.

The steam boilers are standard water tube boilers as known in the art. The steam drum provides water to the boilers and separates steam from the steam-water mixture returning from the boilers. The drums separate saturated water and saturated steam based on a difference in densities. A small portion of the water contained in the steam drum is removed to control buildup of contaminants in the water phase of the drum. This blow-down stream (37) is depressurized and sent to separator (38). The vapor from separator (38) provides some of the low pressure steam needed by deareator (50) while the liquid containing the contaminants (blow down liquid) is normally sent to a facility for treatment and/or disposal.

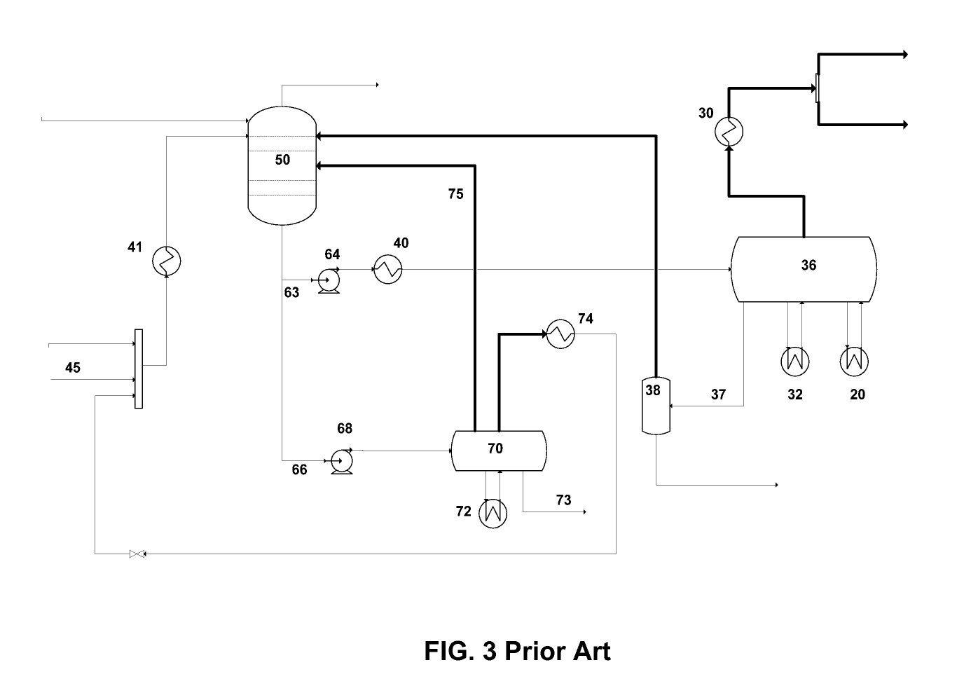

FIG. 3 shows an interpretation of the two level steam system of the steam-hydrocarbon reforming process of U.S. Pat. No. 7,377,951 showing generally the equivalent portion of the steam system coinciding with the portion shown in FIG. 2. For purposes of comparison, only part of the system is discussed. Further, pump elements are included as would be required as determined by the skilled person. Referring to FIG. 3, BFW is heated in heater (41) and sent to deaerator (50) described as a BFW treatment unit in the aforesaid patent. The treated and heated BFW is removed from the deaerator (50), split into two streams with the first stream (63) pumped by a first pump (64) and sent to the BFW heater (40) to make high pressure hot water. The high pressure hot water is sent to high pressure steam drum (36) and then boiled in FG Boiler (32) and PG Boiler (20). The second stream (66) is pressured by second pump (68) and sent to low pressure steam drum (70) where steam is generated in low pressure steam boiler (LPS Boiler) (72). Optionally, second pump (68) can be eliminated by operating deaerator (50) at elevated pressures and by being physically elevated in relationship to LPS Boiler (72). LPS Boiler (72) obtains heat from the process gas and is normally located in the process gas stream between BFW heater (40) and water heater (41), normally a demin water heater, as shown in FIG. 1. Because the quantity of low pressure (LP) steam generated is relatively low, it is often possible to integrate low pressure steam drum (70) and LPS Boiler (72) into a single piece of equipment (not shown). Blow down liquid (73) is removed from the LP steam drum (70) to prevent contaminant build-up due to the concentrating effect associated with boiling. As known in the prior art, the LP steam can be used for a number of purposes such as those shown. According to FIG. 3, a primary purpose is to provide steam for deaerating the BFW in deaerator (50) thereby replacing the use of depressurized high pressure steam as shown in FIG. 2. Since more LP steam can be produced then is needed for deaerator (50), the heat contained in the excess LP steam can be used for a number of applications within the reforming process or outside the reforming process, such as; heating the PSA tail gas as shown by heat exchanger (74) in FIG. 3, heating air prior entering heat exchanger (34) shown in FIG. 1, preheating and/or vaporizing naphtha or other light hydrocarbon liquids that may be used as a feed to the SMR.

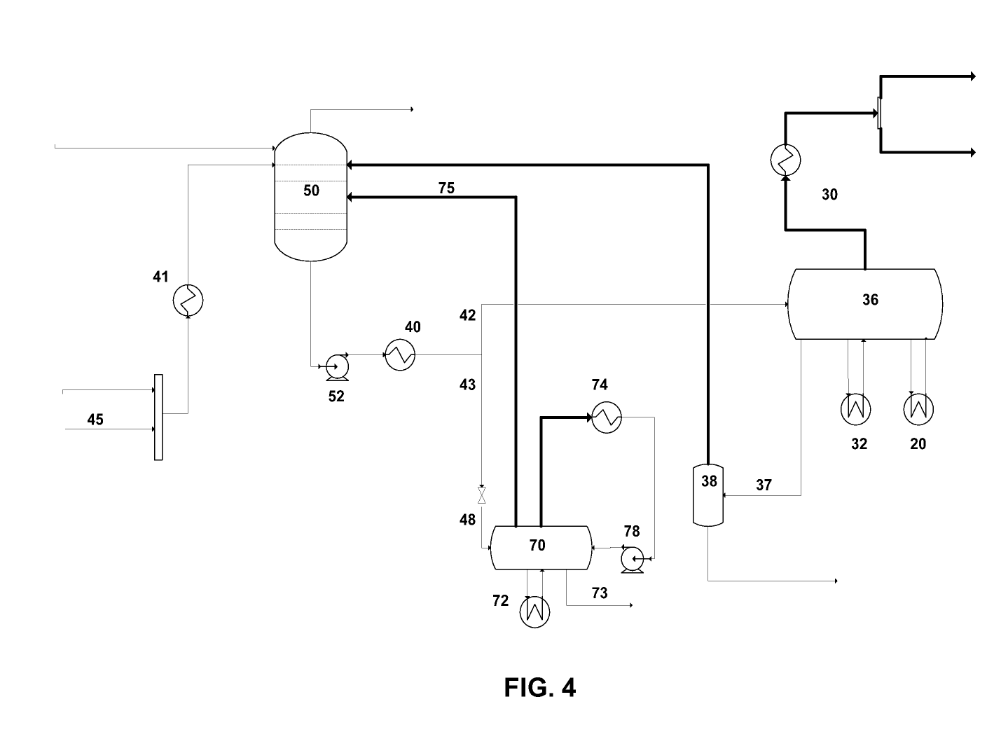

FIG. 4 shows the two level steam system of the steam-hydrocarbon reforming process of the present invention. In reference to the pertinent part of the Figure, BFW is heated in heater (41) and sent to deaerator (50) for treatment. The treated BFW is removed from the deaerator (50) and sent to pump (52) where it is pumped to a pressure of greater than about 300 psig (21 bar), and then fed to BFW heater (40) and heated to a temperature near the boiling point of the pressurized BFW to make high pressure, high temperature BFW. The temperature will vary with the pressure of the high pressure steam, but will typically be between about 400 F and 600 F (about 150 to 300 C). According to one important feature of this invention, substantially the entire stream of treated BFW leaving the deaerator (50) is sent to pump (52) is then to the BFW heater (40). The high pressure BFW leaving the BFW heater (40) is split into two lines (42 and 43) in which a first portion of the high pressure BFW is sent through line 42 to high pressure steam drum (36). High pressure steam drum is in fluid communication with FG Boiler (32) and PG Boiler (20) as conventional in the art. The high pressure steam drum, the FG Boiler and the PG Boiler are described here as the high pressure steam unit. The second portion of the high pressure BFW is sent through line (43), depressurized through valve (48) to reduce the pressure to between about 5 psig to about 75 psig (0.4 to 5.2 bar), and then to LP steam drum (70). LP steam drum (70) can be in fluid communication with and separate from the low pressure boiler (72) as shown or can be an integral part of the boiler, commonly known as a kettle boiler (not shown), with both the drum and boiler being described here as the low pressure steam unit. As shown, a water recycle loop can be used to transfer hot water from the LP steam drum (70) to the LPS boiler (72) and return a mixed steam and water stream back to LP steam drum (70) for separation of the LP steam from the water. Low pressure steam is sent to deaerator (50) through line (75) and to TG preheater (74). Condensate formed as a result of heating the PSA tail gas is heated and sent to pump (78) and back to the LP steam drum (70). Alternatively, the condensate from TG preheater (74) can be returned as condensate and mixed with other streams to the BFW sent to heater (41) (not shown). The TG preheater heats the tail gas leaving PSA unit (44) shown in FIG. 1 and is generally located prior to the point where make-up fuel (13) is added to the TG to form reformer fuel (17).

One advantage of the inventive two level steam system is that the quality of water used in the low pressure steam circuit does not need to meet the same standards as that typically needed for the high pressure steam circuit. Low pressure steam boilers or kettle boilers can tolerate higher levels of hardness and about 10 times the silica levels in the feed water then would be recommended for the high pressure boilers. FIGS. 3 and 4 include a blow-down stream (73) from the LP steam drum (70) which has a primary function of assuring that the water quality within the low pressure steam circuit meets acceptable levels.

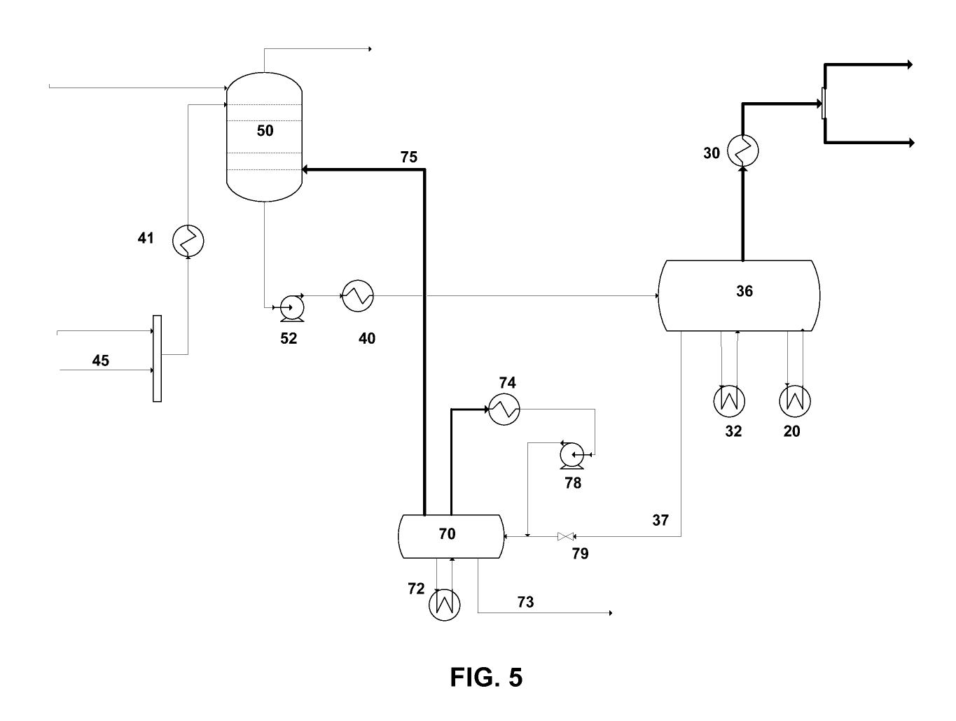

FIG. 5 shows an alternate embodiment of the present invention using a blow down (discharge) stream from the high pressure steam drum to provide make-up water for the low pressure steam circuit. Referring to FIG. 5, stream (37) performs the function as discussed above regarding FIG. 2 and provides the hot water needed to make up for losses associated with the uses of LP steam, i.e., providing steam to the deaerator. The quantity of water flowing through stream (37) in this embodiment is greater than the blow-down require in the configuration shown in FIG. 2. Consequently, the quality of water needed to make the high pressure steam can be reduced. Since stream (37) is saturated with water vapor at the pressure of the high pressure steam drum (36), when stream (37) is depressurized across valve (79), some LP steam is formed. This mixed stream (saturated vapor and saturated water) is fed to the LP steam drum (70) along with other recycle streams such as the PSA tail gas steam sent through TG pre-heater (74) which is also shown fed to the LP steam drum (70) through stream (37). The LP steam drum separates the saturated vapor from the saturated liquid and results in the elimination of separator (38) that is required for the previously described steam systems.

The heat contained in the blow down liquid is seldom recovered because the energy content does not justify the capital requirements. Since the low pressure steam circuit can operate with lower quality water, the overall blow down will be less than in configurations shown in FIGS. 3 and 4 and the water requirements for the process and the temperature losses associated with the blow down liquid will be reduced.

Table 1 below summarizes the performance the SMR designs as shown in FIGS. 1-5. The Figure designation 1/x is used to represent the integration of the individual steam systems shown in FIGS. 2-5 into the overall process as shown in FIG. 1. The efficiency of each design is based on the net natural gas fed to the plant divided by the hydrogen produced. The net natural gas used in the calculation is the overall natural gas rate to the process minus the natural gas that is required to produce the steam exported by the process. Each design that involves low pressure steam production shows a lower total natural gas use than the prior art conventional design. In simulations corresponding to FIGS. 1/2 through 1/4, essentially equivalent quantities of available export steam are produced as in the prior art designs. Thus the efficiency difference is due solely to the reduction in natural gas fed to the process. The low pressure steam in each case is used for deaerating BFW and pre-heating PSA tail gas. The LPS boiler of the design in FIG. 1/4 has a heat transfer duty that is about 12% less than the prior art (FIG. 1/3) while the design of FIG. 1/5 has a duty that is about 6% less than the prior art (FIG. 1/3). The heat transfer duty is directly proportional to the surface area of the low pressure boiler which, in turn, is proportional to the cost of the boiler. The LP steam duty is the quantity of energy that needs to be transferred in heat exchanger (72) to achieve the low level steam production needed for providing the steam for the deaerator and for heating the PSA tail gas. Since the process gas leaving BFW heater (40) is the same in each case and since the LP steam temperature is the same in each of the cases, the LPS duty is directly proportional to the heat transfer area of LPS boiler (72).

TABLE 1

| Design | FIG. 1/2 | FIG. 1/3 | FIG. 1/4 | FIG. 1/5 |
|---|---|---|---|---|
| Efficiency, Btu/scf H₂ | 369 | 365 | 365 | 365 |
| NG to Plant, Btu/scf H₂ | 433 | 429 | 429 | 429 |
| Export HP Steam, Mlb/hr | 185 | 186 | 185 | 186 |
| FG to ID Fan, ° F. | 314 | 314 | 315 | 315 |
| PG to Coolers, ° F. | 264 | 247 | 249 | 249 |
| BFW outlet | 430 | 432 | 430 | 432 |
| preheater, ° F. | | | | |
| TG to burners, ° F. | 100 | 240 | 240 | 240 |
| LPS Duty, MMBtu/hr | NA | 14.4 | 12.7 | 13.5 |

It should be apparent to those skilled in the art that the subject invention is not limited by the simulations or disclosure provided herein which have been provided to merely demonstrate the advantages and operability of the present invention. The scope of this invention includes equivalent embodiments, modifications, and variations that fall within the scope of the attached claims.

What is claimed is:

1. A process for the steam reforming of hydrocarbons to produce hydrogen using a reformer, a water shift reactor, and a hydrogen PSA and incorporating an integrated steam system for processing boiler feed water and steam, the steam system being in fluid communication with the process for steam reforming, the process comprising:
heating boiler feed water to form a heated boiler feed water;
deaerating the heated boiler feed water to make a treated boiler feed water;
pressurizing the treated boiler feed water to make a pressurized boiler feed water;
heating substantially the entire pressurized boiler feed water to near boiling temperature to produce a high pressure heated boiler feed water;
separating the high pressure heated boiler feed water into at least a first portion and a second portion;
feeding the first portion of the high pressure heated boiler feed water to a high pressure steam unit to make saturated boiler feed water to produce high pressure steam;
feeding the second portion of the high pressure heated boiler feed water to a low pressure steam unit for making a low pressure steam; and
sending at least part of the low pressure steam and the high pressure steam to one or more applications within the process for steam reforming or outside the process for steam reforming.

2. The process of claim 1 wherein the high pressure heated boiler feed water is depressured before going to the low pressure steam unit.

3. The process of claim 2 wherein the low pressure steam unit comprises a low pressure steam drum in fluid communication with a low pressure steam boiler.

4. The process of claim 3 to wherein a water recycle loop is used to transfer hot condensate from the low pressure steam drum to the low pressure steam boiler and a mixed steam and water stream is returned to low pressure steam drum for separation of the low pressure steam from the water.

5. The process of claim 4 wherein a first portion of the low pressure steam is sent to the deaerator and a second portion of the low pressure steam is sent to a PSA tail gas preheater where the condensate formed as a result of heating the PSA tail gas is pumped back to the low pressure steam unit.

6. The process of claim 1 wherein the high pressure steam unit comprises a high pressure steam drum in fluid communication with a flue gas boiler and a process gas boiler.

7. The process of claim 1 wherein a discharge stream from the high pressure steam drum is used to provide make-up water for the low pressure steam unit.

8. In a process for the steam reforming of hydrocarbons having an integrated water and steam system and wherein the boiler feed water is deareated to form a deareated boiler feed water, pressured, and then heated to form a high pressure hot water, the improvement comprising sending substantially the entire stream of the deareated boiler feed water to a single pressurizing unit, pressuring the deareated boiler feed water to form a pressurized boiler feed water, heating the pressurized boiler feed water to make high pressure hot water, splitting the high pressure hot water into at least a first portion and a second portion, sending the first portion of the high pressure hot water to high pressure steam unit to make high pressure steam, and depressurizing the second portion of the high pressure hot water and sending it to a low pressure steam unit to make low pressure steam.

9. A steam reforming system using the process of claim 1.

10. A system for the steam reforming of hydrocarbons to produce hydrogen using a reformer, a water shift reactor, and a hydrogen PSA and incorporating an integrated steam system for processing boiler feed water and steam, the steam system comprising:
providing in fluid communication with the process for steam reforming a water heater, a deaerator, a boiler feed water heater, a low pressure steam unit, a high pressure steam unit, and a superheater;
sending boiler feed water to a water heater, heating the boiler feed water and feeding the boiler water to a deaerator to make a treated boiler feed water;
pressurizing substantially the entire stream of the treated boiler feed water to a pressure in excess of about 300 psig to make a pressurized boiler feed water;
feeding the pressurized boiler feed water to the boiler feed water heater,
heating the pressurized boiler feed water to or near boiling temperature to produce a high pressure heated boiler feed water;
feeding at least a portion of the high pressure heated boiler feed water to a high pressure steam unit to make high pressure steam;
sending a discharge water stream from the high pressure steam unit to the low pressure steam unit;
making low pressure steam in the low pressure steam unit and sending at least part of the low pressure steam to the deaerator; and
sending at least part of the high pressure steam and part of the low pressure steam for use in one or more applications within the process for steam reforming or outside the process for steam reforming.

11. The system of claim 10 wherein the discharge stream is depressurized prior to entering the low pressure steam unit.

12. The system of claim 10 wherein the low pressure steam is used for one or more applications selected from heating the PSA tail gas, heating feed air, and preheating naphtha or other light hydrocarbon liquids used as a feed to the steam reforming unit.

13. A process using the system of claim 10.
